(19) United States
(12) Patent Application Publication
(10) Pub. No.: US 2015/0175003 A1
(43) Pub. Date: Jun. 25, 2015

(54) POWER-SAVING APPARATUS AND METHOD FOR TRANSPORTATION VEHICLE

(71) Applicant: YUAN ZE UNIVERSITY, TAOYUAN COUNTY (TW)

(72) Inventors: KUO-SHENG CHAO, TAOYUAN COUNTY (TW); LIANG-CHIH YU, TAOYUAN COUNTY (TW); CHIN-SHENG YANG, TAOYUAN COUNTY (TW); CHIA-YU HSU, NEW TAIPEI CITY (TW); KUO-HUA LAI, TAOYUAN COUNTY (TW); PEI-CHANN CHANG, TAOYUAN COUNTY (TW)

(21) Appl. No.: 14/459,659

(22) Filed: Aug. 14, 2014

(30) Foreign Application Priority Data
Dec. 24, 2013 (TW) 102147842

(51) Int. Cl. B60K 35/00; G07C 5/08; B60L 3/12; G07C 5/02

(52) U.S. Cl. CPC B60K 35/00; G07C 5/02; G07C 5/0808; B60L 3/12; B60K 2350/1056

(57) ABSTRACT

A power-saving apparatus for transportation vehicle is provided. The power-saving apparatus includes an identification module for identifying a user, a positioning module for retrieving a traveled path, a connection interface for retrieving energy consumption data, a memory unit for storing the user data, the traveled path, and the energy consumption data, a microprocessor for calculating an instantaneous energy consumption, an average energy consumption associated with the traveled path. The power-saving apparatus further includes a warning module for generating a warning signal. When the instantaneous energy consumption associated with a first road segment is determined to be larger than a first average energy consumption and/or the instantaneous energy consumption associated with a second road segment is determined to be larger than a second average energy consumption, the warning module operatively generates the warning signal.

### BACKGROUND

1. Technical Field

The present disclosure relates to a power-saving apparatus and a method thereof in particular, to a power-saving apparatus for a transportation vehicle and method thereof

2. Description of Related Art

Energy is an essential element for the industrial developments in fields of agriculture, transportation, communication and the like. Transportation and machinery operations nowadays are required to consume energy such as fuel, gasoline or power to perform operations thereof. The increasing use of energy since industry revolution has brought with it concerns of energy shortages, energy depletion, energy usage efficiency as well as global warming caused by rapid development of energy. Currently, mankind not only continue to use the usable energy converted from nature resources supplied by the environment after thousands of years, but also at same time, looking for alternative energy sources such as renewable energy, alternative energy, nuclear energy, or the like, to ensure the continued existence of mankind. Accordingly, the issue of energy becomes an urgent issue for mankind to solve or to achieve balance between the convenience of human life and the industrial development and the continued existence of the mankind.

### SUMMARY

Accordingly, exemplary embodiments of the present disclosure provide an apparatus that is operable to record and to monitor the energy consumption associated with a transportation vehicle on a traveled path as well as instantly generate warning signals to warn a user, and a method thereof.

An exemplary embodiment of the present disclosure provides a power-saving apparatus for a transportation vehicle, and the power-saving apparatus includes an identification module, positioning module, a connection interface, a memory unit, a microprocessor, and a warning module. The identification module is configured to identify a user. The positioning module operatively retrieves a traveled path of the transportation vehicle, wherein the traveled path comprises of a plurality of road segments. The connection interface is coupled to the transportation vehicle to receive an energy consumption data. The memory unit is configured to store a user data, the traveled path and the energy consumption data. The microprocessor is coupled to the identification module, the positioning module, the connection interface, and the memory unit. The microprocessor is configured to operatively compute the instantaneous energy consumption of the transportation vehicle along the traveled path, and an average energy consumption associated with each road segment. The microprocessor computes the average energy consumption for each respective road segment with the energy consumption data retrieved for the respective road segment traveled at least twice by the transportation vehicle. The warning module is coupled to the microprocessor. The warning module is configured to generate a warning signal. Moreover, the microprocessor operatively compares the instantaneous energy consumption of the transportation vehicle and a first average energy consumption associated with a first road segment as the transportation vehicle travels along the first road segment. When the instantaneous energy consumption associated with the first road segment is determined to be larger than the first average energy consumption, the warning module operatively generates a high energy consumption message. Conversely, when the instantaneous energy consumption associated with the first road segment is determined to be lower than the first average energy consumption, the warning module operatively generates a low energy consumption message.

An exemplary embodiment of the present disclosure provides a power-saving method for a transportation vehicle that has traveled along a traveled path formed of a plurality road segments. The power-saving method includes the following steps. A user is first identified. The road segments traveled in a traveled path, instantaneous energy consumptions associated with road segments traveled and energy consumptions associated with road segments are correspondingly retrieved. The instantaneous energy consumption associated with each respective road segment is compared with the average energy consumption. A warning signal is automatically generated when the instantaneous energy consumption of the transpiration vehicle is determined to be larger than the average energy consumption of the respective road segment traveled. The average energy consumption for each respective road segment is computed according to energy consumption data retrieved for the road segment traveled at least twice by the transportation vehicle.

To sum up, the power-saving apparatus for a transportation vehicle and a power-saving method thereof operatively compute average energy consumptions for the road segments traveled according to the instantaneous energy consumption of the transportation vehicle retrieved while the transportation vehicle is driven, determine whether the instantaneous energy consumption of the transportation vehicle is larger than the average energy consumptions for the respective road segment, and provide information and warnings to the user, accordingly.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram illustrating a power-saving apparatus for a transportation vehicle provided in accordance to an exemplary embodiment of the present disclosure.

FIG. 2A is a diagram illustrating the relationship between a traveled path and the energy consumption of the transportation vehicle provided in accordance to an exemplary embodiment of the present disclosure.

FIG. 2B is a diagram illustrating the relationship between a traveled path and the energy consumption of the transportation vehicle provided in accordance to another exemplary embodiment of the present disclosure.

FIG. 3 is a flowchart illustrating a method for computing the average energy consumption for the road segment traveled provided in accordance to an exemplary embodiment of the present disclosure.

FIG. 4 is a flowchart illustrating a power-saving method for a transportation vehicle provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

(An Exemplary Embodiment of a Power-Saving Apparatus for a Transportation Vehicle)

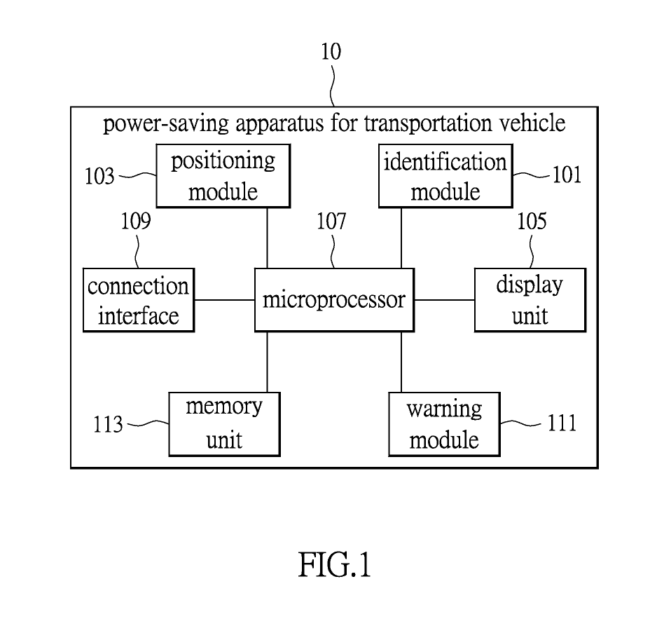

FIG. 1 shows a diagram illustrating a power-saving apparatus for transportation vehicle provided in accordance to an exemplary embodiment of the present disclosure. A power-saving apparatus 10 can be installed on any type of transportation vehicle for obtaining system information thereof. In the instant embodiment, the power-saving apparatus 10 is installed on an automobile. In other embodiments, the power-saving apparatus 10 can be installed on energy-powered transportation vehicles including but not limited to ships and airplanes.

The power-saving apparatus 10 includes an identification module 101, a positioning module 103, a display unit 105, a microprocessor 107, connection interface 109, a warning module 111, and a memory unit 113. In the embodiment of the transportation vehicle being an automobile, the connection interface 109 is configured to connect to a center console of the transportation vehicle. The connection interface 109 in the instant embodiment may for instance be an on-board diagnostics (OBD) interface. Moreover, the power-saving apparatus 10 can connect to the onboard computer of the transportation vehicle through the connection interface 109 to operatively receive the system information, such as the total energy consumption, the instantaneous energy consumption, or the traveling speed.

The identification module 101 is coupled to the microprocessor 107. The identification module 101 is configured to identify a user, particularly, identify the driver of the transportation vehicle. For instance, the identification module 101 is configured to operatively obtain the user information before the user operates the transportation vehicle so as to identify the driver. The identification 101 can include but not limited to radio frequency identification (RFID) module, a Bluetooth module, or a biometric identification module. The biometric identification module can identify or recognize biometric features or unique characteristics of the user including finger print, iris, signature, or voice. In the instant embodiment, the identification module 101 is implemented by a RFID reader which operatively identifies the RFID tag of the driver (i.e., the user).

The positioning module 103 is coupled to the microprocessor 107. The positioning module 103 is configured to retrieve or track a traveled path of the transportation vehicle. The traveled path is paths traveled by the transportation vehicle from a starting point to an ending point. Particularly, while the transportation vehicle is traveling, the positioning module 103 retrieves and records each road segment traveled by the transportation vehicle and the position thereof.

In one embodiment, the traveled path retrieved by the positioning module 103 includes a plurality of road segments and the road segments collectively form a complete traveled path. In the instant embodiment, the transportation vehicle travels sequentially along the road segments of the same or different length. For instance, when the traveled path traveled by the transportation vehicle from a starting point A to an ending point B includes a first road segment and a second road segment, the transportation vehicle sequentially travels along the first and the second segments. The length of the first road segment and the second road segment may be the same or different depending upon the predetermined route. The starting point A and the ending point B may be at the same or different location. It is worth to note that each road segment traveled by the transportation vehicle is an actual trajectory route such as an actual road, a sailing route, and a flight route. The actual trajectory route can include streets, lanes, and alleys for automobiles to travel, or international sailing routes for ships, or flight routes for airplane. In the present disclosure, the positioning module 103 not only is used for retrieving the physical location of the transportation vehicle, but also is used for detecting the road segment currently traveled by the transportation vehicle. Details on detection operation of road segment currently traveled by the positioning module 10 are provided in other embodiments. In the instant embodiment, the positioning module 103 can be the global positioning system (GPS).

The memory unit 113 is coupled to the microprocessor 107. The memory unit is configured to store a user data, the traveled path, and the energy consumption data associated with each road segment. The user data is pre-stored in the user profile in the memory unit 113 and is provided to the identification module 101 to compare the user profile with the driver info obtained. The user data further includes the driving record of the user, wherein the driving record of the user herein may be the driving behavior related information such as a good driver or a bad driver. The memory unit 113 can be implemented by flash memory, read-only memory (ROM), or disk storage, and the present disclosure is not limited to the example provided herein.

The traveled path of the transportation vehicle not only is the map data that corresponding to the path traveled by the transportation vehicle, but also is the actual trajectory route described previously such as an actual road, a sailing route and a flight route. Additionally, the memory unit 113 further is configured to pre-store the traveled path, the transportation vehicle would travel or shall travel and the associated road segments. That is, the power-saving apparatus 10 of the instant embodiment can be configured to pre-store the traveled path of the transportation vehicle and the consecutive or adjoining road segments for the positioning module 103 to verify whether the transportation vehicle is traveling according to the traveled path.

The energy consumption data herein refers to the gasoline consumption data, the power consumption data, or the combination thereof. In the instant embodiment, the energy consumption data is the gasoline consumption data, in particular, is the gasoline consumption data of the petroleum-powered automobile powered by gasoline, diesel, or the like. In other embodiments, the energy consumption data can further include electricity consumption data or electricity and petroleum consumption data. When the transportation vehicle is electric-petroleum powered vehicle, the energy power consumption includes electricity and petroleum consumption data. It shall be noted that as the main concept of the instant embodiment is to monitor the energy consumption state for the same traveled path and the associated road segments traveled by the transportation vehicle, hence the traveled path and the associated road segments traveled by the transportation vehicle are of the same the trajectory route for the same or different user operating the transportation vehicle.

The warning module 111 is coupled to the microprocessor 107. The warning module 111 is configured to generate a warning signal. Explanations on the generation of the warning signal are provided in the subsequent paragraph.

To put it concretely, while the transportation vehicle is driven to travel on the traveled path, the positioning module 103 constantly tracks to obtain the position of the transportation vehicle and the microprocessor 107 retrieves the energy consumption data associated with the operation of the transportation vehicle. Additionally, the microprocessor 107 operatively stores the energy consumption data for each respective road segment of the traveled path in the memory unit 113. For instance, when the transportation vehicle travels on the first road segment, the microprocessor 107 operatively retrieves the energy consumption data of the transportation vehicle traveling along the first road segment and computes the first average energy consumption for the first road segment; when the transportation vehicle travels along the second road segment, the microprocessor 107 operatively retrieves the energy consumption data of the transportation vehicle traveling along the second road segment and computes the second average energy consumption for the second road segment, and so on. When the traveled path includes a plurality of road segments, the microprocessor 107 operatively retrieves the energy consumption data associated with all the road segments, and computes the average energy consumptions, and stores the energy consumption data and the average energy consumptions in the memory unit 113, accordingly. In one embodiment, the physical lengths of the road segments are the same and the average energy consumption of each respective road segment is computed on the basis of 100 meters. In another embodiment, the road segments may be of the same or different length, thus the unit length used for computing the average energy consumption may be different. For instance, the first average energy consumption may be computed on the basis of 500 meters and the second average energy consumption may be computed on the basis of 10 meters. Those skilled in the art shall be able to design the power-saving apparatus 10 to compute the average energy consumption according to the practical operation requirement, and the instant disclosure is not limited thereto.

The microprocessor 107 not only is operable to retrieve and record the energy consumption data associated with each road segment in the traveled path, the microprocessor 107 further records the driving history associated with all users drive the transportation vehicle. In one embodiment, if a first user drives the transportation vehicle to travel all road segments between the starting point A and the ending point B and the microprocessor 107 stores the energy consumption for each of the respective road segments in the memory unit 113, a second user drives the transportation vehicle thereafter and travels the same traveled path and the microprocessor 107 stores the energy consumption for each of the respective road segments in the memory unit 113. That is, the memory unit 113 now stores the energy consumption for the road segments between the starting point A and the ending point B retrieved for the first and the second users, respectively. In another embodiment, the power-saving apparatus 10 can be configured to only store the energy consumption data for each respective road segment without storing information corresponding to the first or the second user. The difference is that the former can analyze the gasoline consumption for various users, and the latter can only analyze the gasoline consumption for the current driver of the transportation vehicle. It is worth to note that, energy consumptions data retrieved for any road segments of the traveled path traveled by the transportation vehicle would still be stored in the memory unit 113 even if the transportation vehicle has not finished traveling the traveled path between the starting point A to the ending point B. The energy consumption data is served as historical energy consumption data provided to the microprocessor 107 for determining whether the subsequent driver of the transportation vehicle exceeds the standard of the historical energy consumption data. Details of using the historical energy consumption data to determine the driving behavior of the driver are described in other embodiments.

(An Exemplary Embodiment of Power-Saving Operation of the Transportation Vehicle while Traveling)

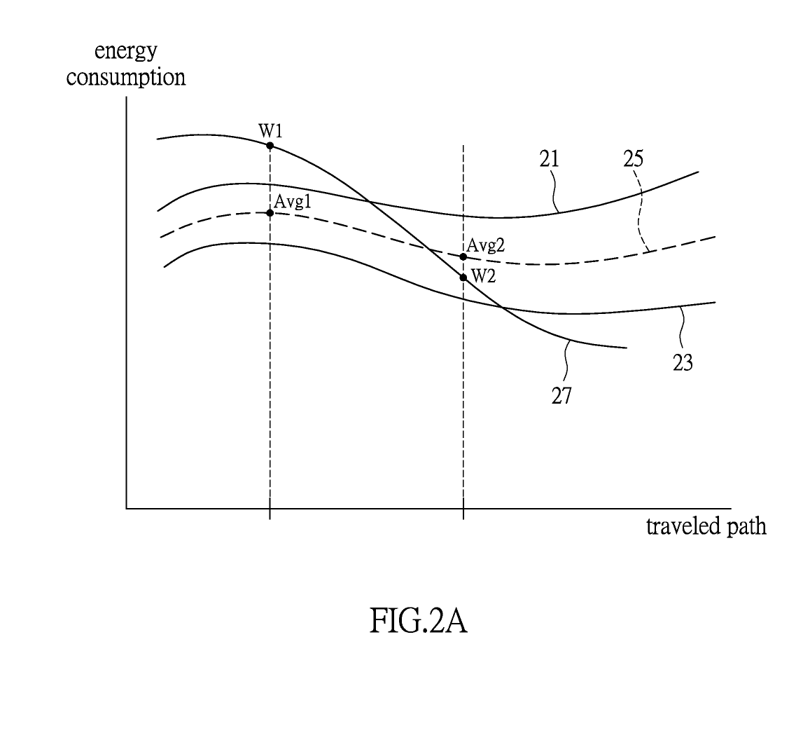

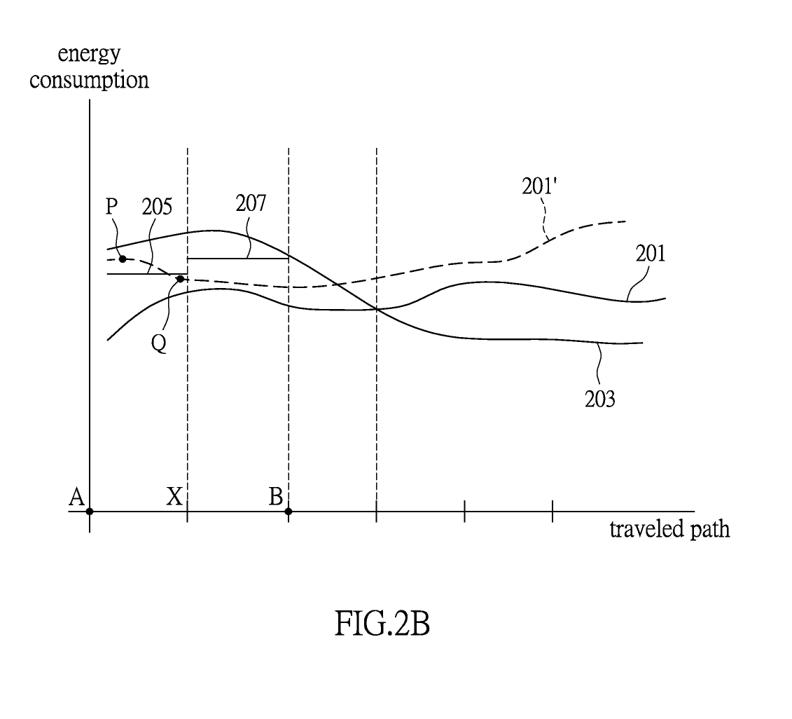

FIG. 2A shows a diagram illustrating the relationship between the traveled path and the average energy consumption provided in accordance to an exemplary embodiment of the present disclosure. The instant embodiment provide explanations not only to the operation of computing the average energy consumption for each road segment while the transportation vehicle traveling, but also to the average energy consumption according to the energy consumption data recorded while the transportation vehicle traveling. Please refer to FIG. 2A in conjunction with FIG. 1, the horizontal axis represents the traveled path, and the vertical axis represents the energy consumption. Curves 21, 23 represent the average energy consumptions of the transportation vehicle obtained one after another with respect to the traveling order of the transportation vehicle and the average energy consumptions are respectively stored in the transportation vehicle. In one embodiment, curve 21 may be the average energy consumption curve associated with road segments being recorded in the memory unit 113 before the transportation vehicle starts traveling. Curve 23 is another average energy consumption curve for the road segments obtained for the subsequent trip made by the transportation vehicle. The power-saving apparatus 10 then computes the average energy consumptions for the road segment using curves 21 and 23, i.e., the curve 25. As can be observed, the average energy consumptions for road segments may vary according to the energy consumed by the transportation vehicle each time the transportation vehicle travels. The average energy consumption curve data is further used to determine the instantaneous energy consumption of the user-operated transportation vehicle, as will be described in the subsequent paragraph.

Specifically, the power-saving apparatus 10 computes the instantaneous energy consumption with the average energy consumption data for road segments lastly computed. For instance, please refer to FIG. 2A again, curve 27 represents the instantaneous energy consumption curve associated with another trip of the transportation vehicle. The point W1 on the curve 27 represents the instantaneous energy consumption of the transportation vehicle traveling along the first road segment. When the energy consumption value at the point W1 is determined to be larger than the first average energy consumption Avg1 associated with the first road segment (i.e., the position of the curve 27 corresponding to the first road segment is higher than that of the curve 25) indicating that the instantaneous energy consumption is larger than the first average energy consumption, the warning module 111 operatively generates a warning signal (such as a warning message) and warn the user that the instant energy consumed by the transportation vehicle has exceeded the average energy consumption consumed by the transportation vehicle before.

Please refer to FIG. 2A, the point W2 of the curve 27 represents the instantaneous energy consumption of the transportation vehicle traveling on the second road segment. As the transportation vehicle travels along the second road segment, the power-saving apparatus 10 operatively determines whether the instantaneous energy consumption is larger than the average energy consumption associated with the second road segment. As illustrated in FIG. 2A, since the instantaneous energy consumption is smaller than the second average energy consumption Avg2 of associated with the second road segment, the warning module 111 therefore would not generate the warning message.

It is worth to note that in the embodiment of FIG. 2, the average energy consumption for each road segment is computed on the basis of the shortest road segment length, such as computing the average energy consumption for each road segment on the basis of 100 meters. Moreover, the power-saving apparatus 10 can also compute the average energy consumption for each road segment correspondingly with different length.

Please refer to FIG. 2B in conjunction with FIG. 1. FIG. 2B shows a diagram illustrating the relationship between the traveled path and the energy consumption provided in accordance to an exemplary embodiment of the present disclosure. The horizontal axis represents the traveled path, and the vertical axis represents the energy consumption. As shown in FIG. 2B, the traveled path AB represents a path from A to B. The traveled path AB includes a first road segment AX and a second road segment XB. That is to say, the first road segment AX and the second road segment XB of the traveled path AB are traveled in sequence (i.e., from the first road segment AX to the second road segment XB). The lengths of the first road segment AX and the second road segment XB may be different.

Please refer to FIG. 2B again, curves 201 and 203 respectively represent the instantaneous energy consumption of the same transportation vehicle driven by a first user and a second user at different time. It is worth to mention that the energy consumption herein is used as historical record data as described previously. The power-saving apparatus 10 computes the average energy consumption for each road segment according to the historical record data. In particular, the power-saving apparatus 10 computes the average of the total energy consumption of the transportation vehicle traveling along the first road segment driven by the first user. Similarly, the power-saving apparatus 10 computes the average of the total energy consumption of the transportation vehicle traveling along the second road segment driven by the first user. The average of the energy consumption may for example be the energy consumption per kilometer, i.e., the energy consumption per unit length. It shall be noted that, the instant disclosure does not limit the unit length to be one kilometer, i.e., the unit length can be set or configured according to the practical operation requirement of the power-saving apparatus or the transportation vehicle. The power-saving apparatus 10 at same time respectively computes the averages of the total energy consumption consumed by the transportation vehicle traveling along the first and the second road segments driven by the second user. Incidentally, the first and the second users are driving or operating the same transportation vehicle at different time and finish traveling the traveled path. The first and the second user may be the same or different user, and the idea herein is that the driver drives the transportation vehicle at different time. The power-saving apparatus 10 computes the first average energy consumption for the first road segment and the second average energy consumption for the second road segment according to the averages of the total energy consumption consumed by the transportation vehicle driven by first and second users while traveling along each respective road segment.

Please refer to FIG. 2B again, the microprocessor 107 determines the driving behavior of the driver according to the first average energy consumption and the second average energy consumption computed. Specifically, the first average energy consumption, as illustrated by curve 205 of FIG. 2B, is the average energy consumed by the transportation vehicle of all users traveling the first road segment. The second average energy consumption, as illustrated by curve 207 of FIG. 2B, is the average energy consumed by the transportation vehicle of all users traveling along the second road segment. The microprocessor 107 computes the average energy consumption for each road segment according to the historical energy consumption data of all the users driving the transportation vehicle traveling along the respective road segment. The microprocessor 107 subsequently determines the driving behavior of the driver according to the average energy consumptions computed for the road segments traveled.

As shown in FIG. 2B, curve 201′ represented by a dash line is the energy consumption curve generated as the first user operates the transportation vehicle again. While the first user drives the transportation vehicle traveling along the first road segment, the power-saving apparatus 10 constantly retrieves the energy consumption data, such as obtaining the instantaneous gasoline consumption or computing the instantaneous gasoline consumption from the amount of gasoline consumed and the associated mileage, of the transportation vehicle through the connection interface 109. The present disclosure dos not limit the method or algorithm used for obtaining the instantaneous consumption. Taking the transportation vehicle as a general petroleum-powered automobile as an example, the instantaneous gasoline may be the amount of liter consumed per 100 kilometer (L/100 km) traveled, or kilometers traveled per each liter (km/L) and the instant embodiment is not limited thereto. However, it shall be noted that the units in all energy consumption computations shall be the same.

After the power-saving apparatus 10 obtains the instantaneous energy consumption of the transportation vehicle while traveling along the first road segment, the power-saving apparatus 10 determines the driving behavior of the driver according to the first average energy consumption. For instance, the instantaneous energy consumption at the point P of the first road segment as depicted by curve 201′ is higher the first average power consumption, the microprocessor 107 operatively determines that the instantaneous energy consumption of the transportation vehicle traveling along the first road segment is larger than the first average energy consumption and causes the warning module 111 to generate a warning signal or display a high energy consumption message to warn the driver that the amount of energy consumed at this instant is larger than the average energy consumption of all users who has drove the transportation vehicle traveling the particular road segment on the record. The warning signal may be the buzz sound signal, the warning light, or the like and the instant disclosure is not limited thereto.

That is to say, the power-saving apparatus 10 is operable to record the historical average energy consumption for all use. The power-saving apparatus 10 further compares the instantaneous energy consumption with the historical average energy consumption when travels along the same road segment to determine whether the instant energy consumed by the transportation vehicle has exceeded the historical average energy consumption for determining the driving behavior of the user. Especially, factors such as instantly speed up or breaks abruptly, would all affect the instantaneous energy consumption and the factors are subjected to the driving habit of the driver, Therefore, if the driver constantly changing the speed of the transportation vehicle, the driver can be intuitively determined to have a bad driving habit.

For instance, as illustrated in FIG. 2B, since the instantaneous power consumption is lower than the first average energy consumption as the first user drives the transportation vehicle traveling the point Q of first road segment, the warning module 111 is driven to either stop generating and issuing warning signal or display low energy consumption message upon determined that the driver is back to normal driving behavior. In the instant embodiment, after the microprocessor 107 determined that the instantaneous energy consumption is larger than the first average energy consumption, the warning module 111 can be driven to continuously generate the warning signal or generate the warning signal every predetermined time until the instantaneous energy consumption of the transportation vehicle is determined to be smaller than the first average energy consumption. Hence, the power-saving apparatus 10 can constantly monitor the instantaneous energy consumption of the transportation vehicle traveling the traveled path and determine whether the instantaneous energy consumption in larger than the average energy consumption of the respective road segment. Accordingly, the power-saving apparatus 10 not only can monitor and record the driving state of the transportation vehicle but also instantly feedback the driver on the driving state of the transportation vehicle.

Referring to FIG. 1 again, the power-saving apparatus 10 further includes a display unit 105, which is configured to display the driving behavior of the user such as display text message of “good driver” or “bad driver”. The purpose of display text message describing the driving behavior is to warn the user to watch the current driving behavior, and the exact message describing the driving behavior can be designed according to the practical operation requirements. For instance, the microprocessor 107 can drive the display unit 105 to display text message of “bad driver” when the instantaneous energy consumption of the first road segment is determined to be larger than the first average energy consumption and/or the instantaneous energy consumption of the second road segment is determined to be larger than the second average energy consumption; otherwise, the microprocessor 107 can drive the display unit 105 to display text message of “good driver” to inspire the driver.

Additionally, the power-saving apparatus 10 can also compute and update the driving record for each user in the historical energy consumption data. For instance, after the first user drives the transportation vehicle and finished traveling the first and the second road segments of the traveled path i.e., curve 201′ of FIG. 2B, the microprocessor 107 re-compute the average energy consumption for each road segment from the total energy consumption of each respective road segment (i.e., the average between the curves 201 and 201′ for each road segment, to obtain the first and the second average energy consumption, for determining whether the next driver fulfill good driver behavior.

Incidentally, the instantaneous energy consumption can refer to the energy consumption per unit time at the instantaneous speed. For example, the instantaneous gasoline consumption (L/100 km) is equal to the gasoline consumption per unit time (L liter/h hour) divided by 100 multiplied by the instantaneous speed (km/h). The above computation merely serves as an illustrational example and the instant disclosure is not limited thereto. The traveled path of the instant embodiment further may include a plurality of adjoining road segments or a plurality of road segments partially overlapped sequentially. The plurality of adjoining road segments here means continue traveling along the second road segment after finished traveling the first rod segment. The plurality of road segments partially overlapped sequentially herein may mean that part of the ending portion of the first road segment and part of the front-end portion of the second road segment are overlapped. Additionally, the adjoining road segments can be paths of the same or different physical lengths, or some of the adjoining road segments are of the same physical lengths. The road segment can be configured to have different physical length depending upon the type of road or operation requirement. For instance, the road segment can be configured to have the same length, such as the shortest length (e.g., 100 meters) for increasing the validity of information used for determining whether the driver satisfies the driving standard. The road segment can be also configured to have the different length, e.g. flat and straight roads or traffic jammed roads have less variation in energy consumption in general, hence the power-saving apparatus 10 can be configured to compute the average energy consumption for longer road segment length. Such that the instantaneous energy consumption obtained is compared with the same average energy consumption for longer road segment. For road segments with greater variation in slope or having lots of curves, the power-saving apparatus 10 can be configured to compute the average energy consumption for shorter road segment length. The related descriptions over the type of road segment are provided herein merely for those skilled in the art to understand the embodiment of the present disclosure and are not intend to limit the scope of the present disclosure.

(An Exemplary Embodiment of a Power-Saving Method for Transportation Vehicle)

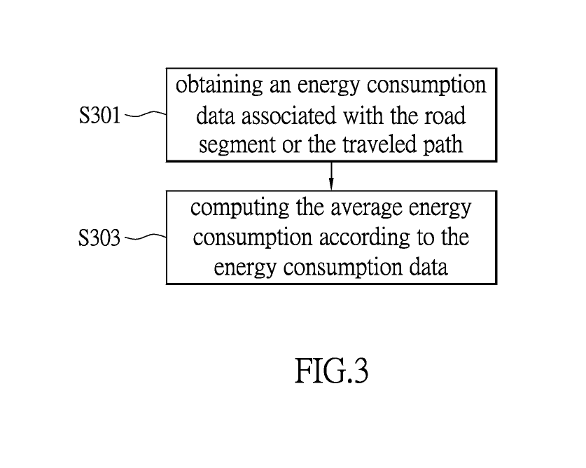

Please refer to FIG. 3, which shows a flowchart illustrating a method for computing the average energy consumption for the road segment traveled provided in accordance to an exemplary embodiment of the present disclosure. The method depicted in FIG. 3 can be utilized by an aforementioned power-saving apparatus of FIG. 1. Multiple energy consumption data associated with a road segment or a traveled path is firstly obtained (Step S301). More specifically, the energy consumption data are the energy consumption of a transportation vehicle driven to travel each respective road segment or a traveled path at least twice. The average energy consumptions for road segments are computed, subsequently. (Step S303) That is, the instant method computes the average energy consumption for each respective road segment according to the historical energy consumption data, wherein the historical energy consumption data are the energy consumption data recorded in corresponding to the road segment or the traveled path being traveled by the transportation vehicle in the past.

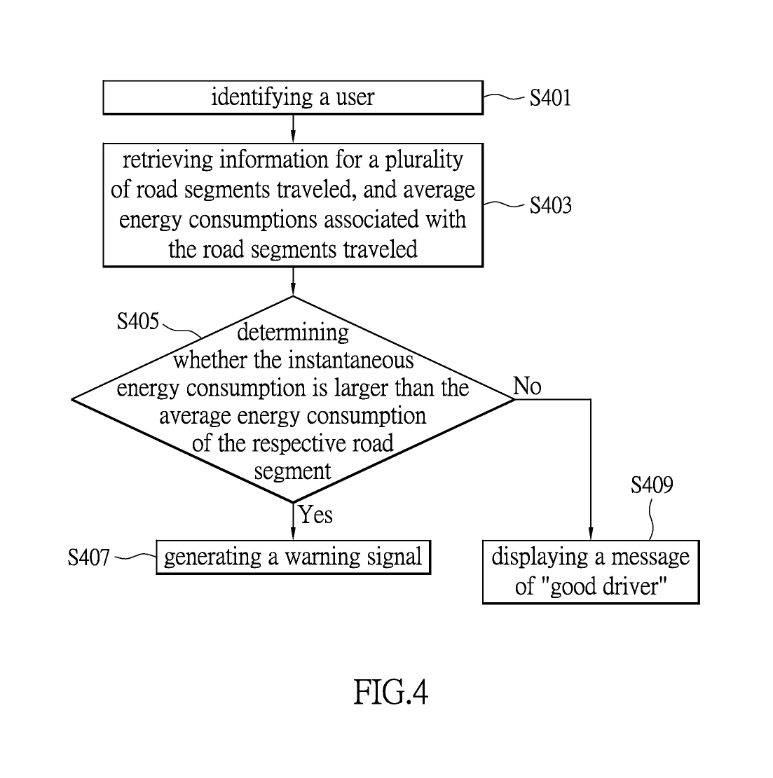

FIG. 4 shows a flowchart illustrating a power-saving method for a transportation vehicle provided in accordance to an exemplary embodiment of the present disclosure. In Step S401, a power-saving apparatus obtains and identify a user. If the user information is not found in a memory unit of the power-saving apparatus, generates a warning signal (such as a warning message) or prohibits the user from driving the transportation vehicle. In Step S403, the power-saving apparatus retrieves the road information associated with the road segment currently travel by the transportation vehicle and the average energy consumption associated with the particular road segment, wherein the road information associated with the road segment currently travel by the transportation vehicle can be for instance the position data retrieved by a GPS. In Step S405, the power-saving apparatus determines whether the instantaneous energy consumption is larger than the average energy consumption. When the power-saving apparatus determined that the instantaneous energy consumption is larger than the average energy consumption, the power-saving apparatus generates a warning signal (such as display a warning message) as in Step S407; otherwise, the power-saving apparatus displays a good driver message indicating that the transportation vehicle is driven in accordance to the standard. The method for obtaining the instantaneous energy consumption can be design based on the practical requirement such as computing the instantaneous energy consumption according to the length of the road segment and the corresponding energy consumption data or directly obtain the instantaneous energy consumption directly from the transportation vehicle system.

Accordingly, the power-saving method described in FIG. 4 can determine the driving behavior of the driver while the driver drives the transportation vehicle based on the history energy consumption data and generate instant feedback. Moreover, in the instant embodiment not only that the user's identification can be verified via a RFID module, a Bluetooth module, or a biometric identification module for reducing the vehicle theft rate or determining illegal driving, the driving condition or behavior of the driver can be further recorded as well. Taking the transportation vehicle as an automobile for example, the power-saving apparatus can equipped with a OBD II interface as the connection interface thereof and connect to the onboard computer of the transportation vehicle to operatively receive the system information, such as the gasoline consumption, the revolution per minute of the transportation vehicle engine, the traveling speed, or the like as well as recording the driving habit of the driver using the power-saving method described in the instant embodiment.

In the instant embodiment, the energy consumption data associated with the road segments traveled by the transportation vehicle are stored in the power-saving apparatus and the energy consumption data are used to compute the average energy consumption for serving as the basis in determining whether the transportation vehicle is traveling according to the average standards. The average energy consumption not only can provide the power-saving apparatus installed on the transportation vehicle as reference for determining the driving condition, the power-saving apparatus can further store the energy consumption data in a remote database (not shown) for other power-saving apparatuses to download and used as determination standard. The power-saving apparatus can further include a communication module and uses the communication module to upload the energy consumption data stored in the memory unit to the remote database or download the energy consumption data from the remote database.

By having a display unit and/or a warning module to warn the driver to change the driving habit, such as steps heavily on the gas pedal or steps on the brake pedal abruptly, to reduce the gasoline consumption or to encourage good driving habit, thereby achieving the purpose of energy-saving. Moreover, danger driving behavior can be reduced as well as accurately analyze the optimal gas-saving driving method when multiple users operating the same transportation vehicle with the identification module equipped. The power-saving apparatus further can analyze the gasoline consumption condition for the same transportation vehicle and conduct the road condition analysis and the gasoline consumption analysis for all users operating the transportation vehicle according to the driver profile (e.g., gender, age, or personality) accompany with different road conditions or type of road traveled (such as mountain roads, streets, alleys, highway, freeways, or country roads)

In summary, the power-saving apparatus and the power-saving method disclosed in the present disclosure can record and monitor the driving behaviors of all users driving the transportation vehicle, and warn the user as to whether to correct the current driving behavior with instant feedback. Accordingly, not only the driving safety can be ensured, at the same time achieve the objective of energy-saving.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A power-saving apparatus for a transportation vehicle, the power saving apparatus comprising:
an identification module, configured to identify a user;
a positioning module, configured to retrieve a traveled path of the transportation vehicle, wherein the traveled path comprises of a plurality of road segments;
a connection interface coupled to the transportation vehicle to receive an energy consumption data;
a memory unit, configured for storing a user data, the traveled path and the energy consumption data;
a microprocessor coupled to the identification module, the positioning module, the connection interface, and the memory unit, the microprocessor configured to compute the instantaneous energy consumption of the transportation vehicle while traveling the traveled path, and an average energy consumption associated with each road segment, wherein the microprocessor computes the average energy consumption for each respective road segment with the energy consumption data retrieved for the respective road segment traveled at least twice by the transportation vehicle; and
a warning module coupled to the microprocessor, configured to generate a warning signal;
wherein the microprocessor operatively compares the instantaneous energy consumption of the transportation vehicle and a first average energy consumption associated with a first road segment as the transportation vehicle travels along the first road segment; when the instantaneous energy consumption associated with the first road segment is determined to be larger than the first average energy consumption, the warning module operatively generates a high energy consumption message; when the instantaneous energy consumption associated with the first road segment is determined to be lower than the first average energy consumption, the warning module operatively generates a low energy consumption message.

2. The power-saving apparatus for the transportation vehicle according to claim 1, wherein the power-saving apparatus further comprises a display unit for displaying the driving behavior of the user, the driving behavior comprises of a good driving behavior or a bad driving behavior, wherein when the microprocessor determined that the instantaneous energy consumption is larger than the first average energy consumption, the display unit operatively displays texts indicating a bad driving behavior.

3. The power-saving apparatus for the transportation vehicle according to claim 1, wherein the connection interface is an on-board diagnostic interface coupled to an onboard computer of the transportation vehicle, wherein the instantaneous energy consumption represents the energy consumption per unit time generated by the transportation vehicle at an instantaneous speed.

4. The power-saving apparatus for the transportation vehicle according to claim 1, wherein the traveled path comprises of a plurality of adjoining road segments or a plurality of road segments partially overlapped sequentially, wherein all adjoining road segments are of the same or different physical lengths, or some of the adjoining road segments are of the same physical lengths.

5. The power-saving apparatus for the transportation vehicle according to claim 1, wherein the identification module is one of a radio frequency identification module, a Bluetooth module, or a biometric identification module.

6. A power-saving method used for a transportation vehicle that has traveled along a traveled path comprised of a plurality road segments, the power-saving method comprising:
identifying a user;
retrieving the plurality of road segments traveled, an instantaneous energy consumption associated with each road segment traveled and average energy consumptions associated with the road segments;
determining whether the instantaneous energy consumption of associated with the road segment is larger than the average energy consumption of the respective road segment; and
generating a warning signal when the instantaneous energy consumption of the transportation vehicle is determined to be larger than the average energy consumption of the respective road segment traveled;
wherein the average energy consumption for each respective road segment is computed according to the energy consumption data retrieved for the respective road segment traveled at least twice by the transportation vehicle.

7. The power-saving method for the transportation vehicle according to claim 6, wherein the step of retrieving the plurality of road segments further comprises of computing the instantaneous energy consumption based on the length of the road segment traveled and the energy consumption data retrieved for the respective road segment when determined that the transportation vehicle has not completed travel through the road segment.

8. The power-saving method for the transportation vehicle according to claim 7, wherein when determined that the transportation vehicle has finished travel through the road segment but has not finished travel through the traveled path, causes the transportation vehicle to continue to travel the next road segment and determines whether the instantaneous energy consumption associated with transportation vehicle is larger than the average energy consumption of the next respective road segment.

9. The power-saving method for the transportation vehicle according to claim 8, wherein when determined that the transportation vehicle has finished travel through the traveled path, respectively computes the average energy consumptions for the road segments traveled.

10. The power-saving method for the transportation vehicle according to claim 9, wherein the instantaneous energy consumption is equal to the energy consumption per unit time divided by the instantaneous speed of the transportation vehicle.
